(19) United States
(12) Patent Application Publication
(10) Pub. No.: US 2007/0212934 A1
(43) Pub. Date: Sep. 13, 2007

(54) Circuit Board With At Least One Connection Bore For A Connection Wire Or Pin Of A Wired Electronic Component

(75) Inventors: Dietmar Birgel, Schopfheim (DE); Karl-Peter Hauptvogel, Bartenheim (FR)

Correspondence Address: BACON & THOMAS, PLLC, 625 SLATERS LANE, FOURTH FLOOR, ALEXANDRIA, VA, 22314, US

(73) Assignee: Endress + Hauser GmbH + Co. KG, Maulburg, (DE)

(21) Appl. No.: 10/593,344

(22) PCT Filed: Mar. 17, 2005
(86) PCT No.: PCT/EP05/51235

§ 371 Date: May 4, 2007

(30) Foreign Application Priority Data
Mar. 19, 2004 (DE) 10 2004 014 034.0

(51) Int. Cl. H01R 13/60

(52) U.S. Cl. 439/567

(57) ABSTRACT

A circuit board with a holding mechanism integrated into the circuit board for the holding of wired, electronic components. To this end, a connection bore is provided for receiving a connection wire or pin of the component. The connection bore is formed from two neighboring and partially mutually overlapping bores. In such case, the first bore is so placed relative to a second bore that ridges are formed in the interior of the connection bore as a result of the overlapping of the first and second bores. The ridges provide a narrowing of the open passageway through the connection bore. In this narrowing, the connection wire or pin is controllably, securely seized by the ridges.

The invention relates to a circuit board having a holding mechanism for holding wired electronic components.

Various methods and mechanisms are known with which wired electronic components can be so affixed on circuit boards that they do not slip or otherwise change their position during populating or during transport of the circuit board with the components populated thereon to a soldering apparatus. Similar mechanisms are also used for holding wired components of unfavorable mass distribution on the circuit board during selective soldering.

The term wired components is intended here to encompass all electronic components having at least one connection wire or one connection pin which is stuck through or into a corresponding usual connection bore of the circuit board and is soldered on or with a desired contact location, in order to establish the electrical contacting of the component. Wired components in this sense can also include in-line connectors, contact wires or Litz wires, and even transformers and other active or passive electronic components.

Especially in the case of components of large mass or nonuniform mass distribution, the simple sticking of the connection wires or connection pins into or through the connection bores is not sufficient to assure a secure mechanical holding of the components during selective soldering or during transport to or through an automatic soldering apparatus.

In the case of selective soldering, it has been found that, frequently, a mechanism is lacking for affixing the described components in a position which allows soldering.

Frequently, also wired components of the described kind are, to this point in time, shaken out of the circuit board when on unsteady or jerking transport bands on the way to an automatic soldering apparatus or on the way through the automatic soldering apparatus. There are also known instances where the said wired components are pressed out of the circuit board by the solder wave in a wave soldering apparatus. Even when the components do not fall completely out of the circuit board under the mentioned unfavorable conditions, it can happen that they assume an undesired position or orientation on the circuit board which can be problematic or even harmful for the soldering.

When also the form of the connection bore does not match the cross sectional form of the connection pin or wire of the component under consideration, the above described problems become even more noticeable.

In order to attempt to overcome the described problems, it has been the practice, to this point in time, to use adhesive, for example, to hold the components in question on the circuit board, or to use mechanical, for example, snap-in, holders on the circuit board. These methods are, however, complicated and associated with additional costs, since they require additional components and an extra processing step for the placement of the special components.

An object of the invention, therefore, is to provide a circuit board having a holding mechanism for the secure holding of the connection wires or pins of components and so to avoid the above described disadvantages without requiring that the components in question be held by adhesive or holding elements additionally placed on the circuit boards.

This object is achieved by a circuit board having at least one connection bore for receiving a connection wire or pin of an electronic component of predetermined pin or wire cross section, wherein the connection bore is formed from at least two neighboring and partially overlapping bores and wherein the two bores are placed in such a manner with respect to one another that a narrowing is formed in the interior of the connection bore which controllably seizes the connection wire or pin in the connection bore.

In a preferred form of embodiment of the circuit board of the invention, the seizing effect of the narrowing of the connection bore is adjustable by suitable choice of the separation of the bores with respect to one another and taking into consideration the pin or wire cross section.

In another form of embodiment of the circuit board of the invention, the bores have different diameters.

The bores in the case of a further form of embodiment of the circuit board of the invention are drilled from the same side of the circuit board.

In yet another embodiment of the circuit board of the invention, the actual number of bores, which form the connection bore, is selected as a function of the cross sectional shape of the connection pin or wire to be received.

In again another embodiment of the circuit board of the invention, the connection bore formed from the bores is over-drilled by a central, nontraversing, blind-hole bore.

In yet another embodiment of the circuit board of the invention, it is provided that the connection bore is metallized.

A great advantage of the invention is that it can be implemented in simple manner and does not require unconventional process steps during the manufacture of the circuit board of the invention. The bores required for the invention neighboring and partially overlapping one another can be drilled independently from the same side of the circuit board. The circuit boards can thus be drilled according to a known method wherein they are stacked together. It has also been found that the desired positioning of the neighboring bores with respect to one another can be reproducibly achieved in the same manner as the obtaining of the other dimensions of the circuit boards.

The over-drilling of the connection bore in a special form of embodiment of the invention provides an additional possibility for controlling the amount of the seizing action on the connection wire or pin under consideration.

The invention will now be explained in greater detail on the basis of description of different examples of embodiments presented in the appended drawing, the figures of which show as follows:

FIG. 1 A schematic top view onto a first form of embodiment of a circuit board of the invention;

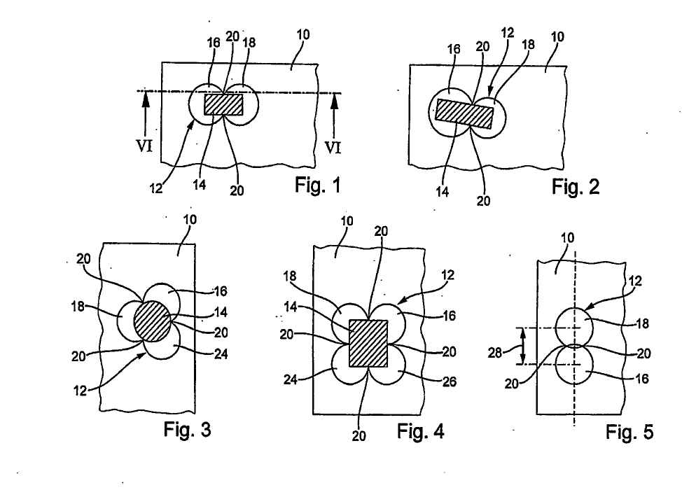

FIG. 2 a schematic top view onto a second form of embodiment of a circuit board of the invention;

FIG. 3 a schematic top view onto a third form of embodiment of a circuit board of the invention;

FIG. 4 a schematic top view onto a fourth form of embodiment of a circuit board of the invention;

FIG. 5 a further schematic top view onto the form of embodiment of the circuit board of FIG. 1;

FIG. 6 a schematic, sectional view of the circuit board of FIG. 1 taken according to the cutting plane VI-VI of FIG. 1; and

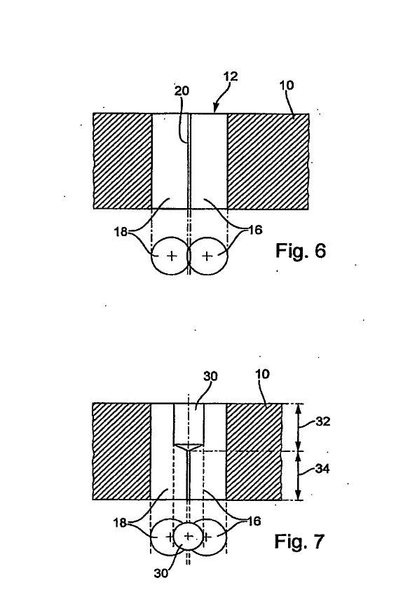

FIG. 7 a schematic, sectional view of a special form of embodiment of the circuit board of FIG. 6 showing an over-drilling of the connection bore.

For simplification and for improving overviewability, equal elements and modules in the drawing are provided with equal reference characters.

FIG. 1 shows a circuit board 10 having a connection bore 12 for receiving a connection wire or pin 14 of an electronic component. (For reasons of simplification, the entire electronic component is not shown here.) Connection wire or pin 14 has, by way of example, a rectangular cross section. The connection bore 12 is, in the case of this example of an embodiment of a circuit board 10 of the invention, formed from two neighboring and partially overlapping bores 16 and 18, with the first bore 16 being placed relative to the second bore 18 in such a manner that in the interior of the connection bore 12 due to the overlapping of the bores 16, 18, ridges 20 are formed, which create a narrowing of the open passageway through the connection bore 12. In this narrowing, the connection wire or pin 14 is controllably, securely seized by the ridges 20 in the connection bore 12. The drawing of FIG. 1 makes clear the special suitability of this form of embodiment of the circuit board 10, with a connection bore 12 formed from two bores 16, 18, for connection pins or wires 14 of rectangular cross section.

FIG. 2 shows a second example of an embodiment of the circuit board 10 of the invention. In contrast to the form of embodiment presented in FIG. 1, where the first and second bores 16, 18 have essentially equal diameters, here, in the case of the form of embodiment of the circuit board 10 presented in FIG. 2, the connection bore 12 is formed of two bores 16, 18, which have different diameters. Also, this form of embodiment of the circuit board 10, with the connection board 12 formed from two bores 16, 18 of different diameter, is especially suited for connection pins or wires 14 of rectangular cross section.

A further example of an embodiment of the circuit board 10 of the invention is presented in FIG. 3. Here the connection bore 12 is formed of three overlapping bores 16, 18, 24. As FIG. 3 also shows, such a connection bore 12 leads to three ridges 20 which are suited in special manner for securely seizing a connection pin or wire 14 having a circular cross section.

For a connection pin or wire 14 of square cross section, in contrast, the example of an embodiment of the circuit board 10 of the invention presented in FIG. 4 is especially suited. In the case of this embodiment, the connection bore 12 is formed from four overlapping bores 16, 18, 20, 24, so that here four ridges 20 are formed, with which the connection pin or wire 14 can be securely held.

FIG. 5 illustrates, on the basis of the example of the circuit board 10 of FIG. 1, how, by changing the separation 28 of the axes of the bores 16, 18, the amount with which the ridges protrude into the connection bore can be adjusted, such being responsible for the actual seizing effect on the connection pin or wire 14. The greater the separation of the axes of the bores, the smaller is the seizing action for constant diameter of the connection wire or pin. By adjusting the seizing action, also the required compressive force is determined, which must be exerted on a component in order to press its connection pin or wire 14 into the connection bore 12 and, indeed, against the resistance of the ridges 20.

It is clear for those skilled in the art that also in the case of the other examples of embodiments of the circuit boards 10 of the invention presented in FIGS. 2-4, the separations of the axes of the bores can be adjusted with respect to one another, such that, in this way, the desired seizing action is achieved on the connection pin or wire 14 under consideration in any given case.

For further clarification of the nature of the ridges 20, FIG. 6 shows, schematically, a section through the circuit board of FIG. 1 and, indeed, along a cutting plane indicated in FIG. 1 by VI-VI. Clearly recognizable is the connection bore 12 formed from the overlapping bores 16, 18, and the ridge 20 in its central area. In the lower part of FIG. 6, again the representation of the two bores 16 and 18, with their axes, is shown, in order to indicate the possibilities in the varying of the separations of the axes as indicated in FIG. 5.

In the case of a special form of embodiment which proceeds from a circuit board 10 of FIG. 5, the connection bore 12 formed from the two mutually overlapping bores 16, 18 is over-drilled with an additional, non-traversing, or blind, hole 30. The connection bore 12 obtained in this way is illustrated in a sectional drawing in FIG. 7, based on FIG. 6. The diameter of the over-drilled blind-hole bore 30 is smaller than the one, or two, diameters of the bores 16, 18, and slightly greater than the shortest separation of the tips of the ridges 20 protruding into the connection bore 12. By a suitable choice of a depth 32 of the over-drilled, blind-hole bore 30 it is possible to so adjust the ridge height 34 remaining in the connection bore 12, such that the seizing action exerted by the ridges 20 on the relevant connection pin or wire 14 (see in this connection FIGS. 1-4) is optimized.

Although in the case of the example of an embodiment of the invention shown in FIG. 7, a connection bore 12 formed from two bores 16, 18, is shown with an over-drilled, blind-hole bore 30, it is clear for those skilled in the art that the over-drilled, blind-hole bore 30 can also be used in the examples of embodiments of circuit boards 10 shown in FIGS. 2-4.

In principal, it is arbitrary from which side of the circuit board 10, the bores 16, 18, 24, 26, or also the over-drilled, blind-hole bore 30 are drilled. When useful, these bores could also be drilled from different sides of the circuit board. Should the bores 16, 18, 24, 26, forming the connection bore 12, be bored from a single side of the circuit board 10, then it is possible to bore or drill a plurality of circuit boards together in a single stack. For an over-drilled, blind-hole bore, it is then, however, necessary to process each of the circuit boards separately.

In order to optimize the soldering of the connection pin or wire 14 of the component held in the connection bore 12, be it for a soldering process in a soldering oven, in a wave soldering bath, or a case of selective soldering, the connection bore 12 is preferably metallized.

1-7. (canceled)

8. A circuit board with at least one connection bore for receiving a connection wire or pin of an electronic component of a predetermined pin or wire cross section, the improvement wherein:
said at least one connection bore is formed from at least two neighboring and partially, mutually overlapping bores, said two bores are placed relative to one another in such a manner that a narrowing is formed in the interior of said at least one connection bore and the narrowing controllably, securely seizes the connection wire or pin said at least one connection bore.

9. The circuit board as claimed in claim 8, wherein:
by suitable choice of the separation of said bores mutually overlapping relative to one another and by taking into consideration the pin or wire cross section, the seizing action of the narrowing of said at least one connection bore is adjustable.

10. The circuit board as claimed in claim 8, wherein:
said overlapping bores have different diameters.

11. The circuit board as claimed in claim 8, wherein:
said overlapping in bores are drilled from the same side of the circuit board.

12. The circuit board as claimed in claim 8, wherein:
the actual number of said overlapping bores forming said at least one connection bore is selected as a function of the cross sectional shape of said connection pin or wire to be received.

13. The circuit board as claimed in claim 8, wherein:
said at least one connection bore formed from said overlapping bores is over-drilled by a central, nontraversing, blind-hole bore.

14. The circuit board as claimed in claim 8, wherein:
said at least one connection bore is metallized.
